(19) United States
(12) Patent Application Publication
(10) Pub. No.: US 2020/0236218 A1
(43) Pub. Date: Jul. 23, 2020

(54) TECHNIQUES FOR BEHAVIORAL PAIRING IN A TASK ASSIGNMENT SYSTEM

(71) Applicant: Afiniti, Ltd., Hamilton (BM)

(72) Inventor: Jason DELKER, Olathe, KS (US)

(73) Assignee: Afiniti, Ltd., Hamilton (BM)

(21) Appl. No.: 16/250,495

(22) Filed: Jan. 17, 2019

(51) Int. Cl. H04M 3/523; H04M 3/42

(52) U.S. Cl. CPC H04M 3/5232; H04M 3/42357; H04M 3/42059

(57) ABSTRACT

Techniques for behavioral pairing in a task assignment system are disclosed. In one particular embodiment, the techniques may be realized as a method for behavioral pairing in a task assignment system comprising receiving, by at least one computer processor communicatively coupled to and configured to operate in the task assignment system, information associated with a task to be assigned to an agent in the task assignment system, wherein receipt of the information is triggered by an action taken by a user.

### FIELD OF THE DISCLOSURE

The present disclosure generally relates to behavioral pairing and, more particularly, to techniques for behavioral pairing in a task assignment system.

### BACKGROUND OF THE DISCLOSURE

A typical task assignment system algorithmically assigns tasks arriving at the task assignment center to agents available to handle those tasks. At times, the task assignment system may have agents available and waiting for assignment to tasks. At other times, the task assignment center may have tasks waiting in one or more queues for an agent to become available for assignment.

In some typical task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an “L2” environment, multiple tasks are waiting in a queue for assignment to an agent. When an agent becomes available, the task at the head of the queue would be selected for assignment to the agent. In these typical task assignment centers, specific information about the task is not used to optimize the assignment of the task to an agent.

In view of the foregoing, it may be understood that there may be a need for a system that provides specific information about tasks, as early as possible (e.g., as soon as the task is initiated) in order to optimize overall performance of a task assignment system, particularly one that uses a behavioral pairing (BP) strategy.

### SUMMARY OF THE DISCLOSURE

Techniques for behavioral pairing in a task assignment system are disclosed. In one particular embodiment, the techniques may be realized as a method for behavioral pairing in a task assignment system comprising receiving, by at least one computer processor communicatively coupled to and configured to operate in the task assignment system, information associated with a task to be assigned to an agent in the task assignment system, wherein receipt of the information is triggered by an action taken by a user.

In accordance with other aspects of this particular embodiment, the task assignment system may be a contact center system.

In accordance with other aspects of this particular embodiment, the action may have been taken by the user prior to a request for the task to be assigned to an agent in the task assignment system.

In accordance with other aspects of this particular embodiment, the task may be assigned to the agent based at least in part on the received information associated with the task.

In accordance with other aspects of this particular embodiment, the task may be terminated prior to being assigned to the agent.

In accordance with other aspects of this particular embodiment, the information associated with the at least one task may be at least one of a geographical location of where the at least one task originates and a customer identification of a user initiating the at least one task.

In another particular embodiment, the techniques may be realized as a system for behavioral pairing in a task assignment system comprising at least one computer processor communicatively coupled to and configured to operate in the task assignment system, wherein the at least one computer processor is further configured to perform the steps in the above-described method for behavioral pairing in a task assignment system.

In another particular embodiment, the techniques may be realized as an article of manufacture for behavioral pairing in a task assignment system comprising a non-transitory processor readable medium and instructions stored on the medium, wherein the instructions are configured to be readable from the medium by at least one computer processor communicatively coupled to and configured to operate in the task assignment system and thereby cause the at least one computer processor to operate so as to perform the steps in the above-described method for behavioral pairing in a task assignment system.

In yet another particular embodiment, the techniques may be realized as a method for behavioral pairing in a contact center system comprising: identifying, by at least one computer processor communicatively coupled to and configured to operate in the contact center system, a request initiated by a user to contact the contact center system; and requesting, by the at least one computer processor, information associated with the user or a device of the user.

In accordance with other aspects of this particular embodiment, the method may further comprise receiving, by the at least one computer processor, the information.

In accordance with other aspects of this particular embodiment, the user may not contact the contact center system.

In accordance with other aspects of this particular embodiment, the user may contact the contact center system, and the method may further comprise selecting, by the at least one computer processor, an agent based at least in part on the received information.

In accordance with other aspects of this particular embodiment, the user may contact the contact center system, and the method may further comprise selecting, by the at least one computer processor, an agent script or an interaction with an agent based at least in part on the received information.

In yet another particular embodiment, the techniques may be realized as a system for behavioral pairing in a contact center system comprising at least one computer processor communicatively coupled to and configured to operate in the contact center system, wherein the at least one computer processor is further configured to perform the steps in the above-described method for behavioral pairing in a contact center system.

In yet another particular embodiment, the techniques may be realized as an article of manufacture for behavioral pairing in a contact center system comprising a non-transitory processor readable medium and instructions stored on the medium, wherein the instructions are configured to be readable from the medium by at least one computer processor communicatively coupled to and configured to operate in the contact center system and thereby cause the at least one computer processor to operate so as to perform the steps in the above-described method for behavioral pairing in a contact center system.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a task assignment system according to embodiments of the present disclosure.

FIG. 2 shows a flow diagram of a task assignment method according to embodiments of the present disclosure.

FIG. 3 shows a flow diagram of a task assignment method according to embodiments of the present disclosure.

### DETAILED DESCRIPTION

A typical task assignment system algorithmically assigns tasks arriving at the task assignment center to agents available to handle those tasks. At times, the task assignment system may have agents available and waiting for assignment to tasks. At other times, the task assignment center may have tasks waiting in one or more queues for an agent to become available for assignment.

In some typical task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an “L2” environment, multiple tasks are waiting in a queue for assignment to an agent. When an agent becomes available, the task at the head of the queue would be selected for assignment to the agent. In these typical task assignment centers, specific information about the task is not used to optimize the assignment of the task to an agent.

In view of the foregoing, it may be understood that there may be a need for a system that provides specific information about tasks, as early as possible (e.g., as soon as the task is initiated) in order to optimize overall performance of a task assignment system, particularly one that uses a behavioral pairing (BP) strategy.

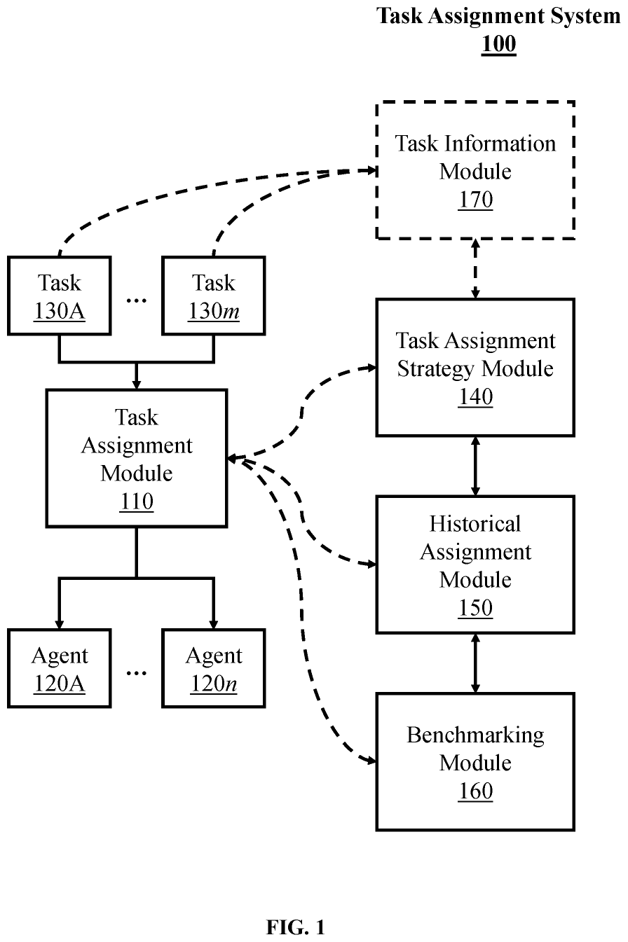

FIG. 1 shows a block diagram of a task assignment system 100 according to embodiments of the present disclosure. The description herein describes network elements, computers, and/or components of a system and method for benchmarking pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 1, the task assignment system 100 may include a task assignment module 110. The task assignment system 100 may include a switch or other type of routing hardware and software for helping to assign tasks among various agents, including queuing or switching components or other Internet-, cloud-, or network-based hardware or software solutions.

The task assignment module 110 may receive incoming tasks. In the example of FIG. 1, the task assignment system 100 receives m tasks over a given period, tasks 130A-130m. Each of the m tasks may be assigned to an agent of the task assignment system 100 for servicing or other types of task processing. In the example of FIG. 1, n agents are available during the given period, agents 120A-120n. m and n may be arbitrarily large finite integers greater than or equal to one. In a real-world task assignment system, such as a contact center, there may be dozens, hundreds, etc. of agents logged into the contact center to interact with contacts during a shift, and the contact center may receive dozens, hundreds, thousands, etc. of contacts (e.g., calls) during the shift.

In some embodiments, a task assignment strategy module 140 may be communicatively coupled to and/or configured to operate in the task assignment system 100. The task assignment strategy module 140 may implement one or more task assignment strategies (or “pairing strategies”) for assigning individual tasks to individual agents (e.g., pairing contacts with contact center agents).

A variety of different task assignment strategies may be devised and implemented by the task assignment strategy module 140. In some embodiments, a FIFO strategy may be implemented in which, for example, the longest-waiting agent receives the next available task (in L1 environments) or the longest-waiting task is assigned to the next available agent (in L2 environments). Other FIFO and FIFO-like strategies may make assignments without relying on information specific to individual tasks or individual agents.

In other embodiments, a PBR strategy for prioritizing higher-performing agents for task assignment may be implemented. Under PBR, for example, the highest-performing agent among available agents receives the next available task. Other PBR and PBR-like strategies may make assignments using specific information about agents but without necessarily relying on specific information about tasks.

In yet other embodiments, a BP strategy may be used for optimally assigning tasks to agents using specific information about either tasks or agents, or both. Various BP strategies may be used, such as a diagonal model BP strategy or a network flow BP strategy. These task assignment strategies and others are described in detail for the contact center context in, e.g., U.S. Pat. Nos. 9,300,802 and 9,930,180, which are hereby incorporated by reference herein. BP strategies may be applied in an “L1” environment (agent surplus, one task; select among multiple available/idle agents), an “L2” environment (task surplus, one available/idle agent; select among multiple tasks in queue), and an “L3” environment (multiple agents and multiple tasks; select among pairing permutations).

When the task assignment system 100 uses a BP strategy that relies on specific information about incoming tasks, a task information module 170 may be communicatively coupled to and/or configured to operate in the task assignment system 100 via the task assignment strategy module 140. In some embodiments, the task information module 170 may store predetermined specific information about a task (e.g., information about a caller based on the phone number from which a call originates, information from a customer relationship management (CRM) database, etc.). In other embodiments, the task information module 170 may receive and store specific information about a task as the task is initiated. For example, useful information such as a task or customer identifier, geographic location of the user, state of the user device or application from which the task is initiated, etc. Such useful information may be retrieved when an action is taken by a potential task (or contact, customer, etc.) prior to the task arriving at the task assignment system 100.

For instance, a caller may place a call to a call center from a cellular phone or uses a “click-to-call” button on a browser or a mobile application (“app”). In parallel with initiating the call, the user's device may be configured to transfer data to the task assignment system 100 or, in particular, to the task information module 170. For example, the user's customer identification and geographical location may be transmitted. Consequently, the task assignment system 100 may be informed of the location from which a particular customer is calling or is about to call. It is to be noted that there may be cases where, although the initiation of a call may transmit information to the task information module 170, the task itself may be terminated prior to arriving at the task assignment system 100. In other words, the caller does not make contact with the task assignment system 100 and no agent needs to be assigned to that potential task.

In some embodiments, when the task arrives at the task assignment system 100, the task assignment strategy module 140 may query the task information module 170 for specific information associated with the task. In other embodiments, the task assignment strategy module 140 may query the task information module 170 prior to the task arriving at the task assignment system 100 (e.g., when a contact center system is notified of a user-initiated request to contact the contact center). A query to the task information module 170 may be based on at least one variable such as a telephone number or other identifier pertaining to the task. The variable upon which the query is based may not be predetermined or known prior to the task arriving at the task assignment system 100. In yet other embodiments, the task information module 170 may provide specific information associated with a task to the task assignment strategy module 140 prior to the task arriving at the task assignment system 100 (e.g., when a user initiates a request to contact a contact center).

With the specific information associated with the task, the task assignment strategy module 140 thus may better inform the BP strategy about the task such that the task gets assigned to the most appropriate available agent. The specific information may also inform an agent script or an interaction with the agent. Therefore, the overall performance of the task assignment system 100 may be improved.

In some embodiments, the task information module 170 may be local to or included in the task assignment system 100 such that specific information associated with tasks stored in the task information module 170 may be transferred readily to the task assignment strategy module 140. In other embodiments, the task information module 170 may be one or more data sources external to the task assignment system 100, such as a customer relationship management (CRM) database, a localized file of third-party data, task/call history data, sales data, task/customer interaction data, interactive voice response (IVR) or switch data, etc. In some embodiments, the task information module 170 may be an external data source that is not within a firewall or other shared security perimeter of the task assignment system 100, such as government, commercial, vendor, or social media database.

The task assignment strategy module 140 may perform a remote lookup to access data stored in external data sources. The task assignment strategy module 140 may query more than one data source at the same time, in parallel. The remote data lookup may be performed without increasing the average overall time that elapses in making a task assignment (e.g., without increasing the average wait time of a caller to a call center). In some embodiments, the average wait time may increase, but by a limited amount (e.g., by not more than 5 seconds, 20 seconds, etc.).

In some embodiments, a historical assignment module 150 may be communicatively coupled to and/or configured to operate in the task assignment system 100 via other modules such as the task assignment module 110 and/or the task assignment strategy module 140. The historical assignment module 150 may be responsible for various functions such as monitoring, storing, retrieving, and/or outputting information about agent task assignments that have already been made. For example, the historical assignment module 150 may monitor the task assignment module 110 to collect information about task assignments in a given period. Each record of a historical task assignment may include information such as an agent identifier, a task or task type identifier, outcome information, or a pairing strategy identifier (i.e., an identifier indicating whether a task assignment was made using a BP pairing strategy or some other pairing strategy such as a FIFO or PBR pairing strategy).

In some embodiments and for some contexts, additional information may be stored. For example, in a call center context, the historical assignment module 150 may also store information about the time a call started, the time a call ended, the phone number dialed, and the caller's phone number. For another example, in a dispatch center (e.g., “truck roll”) context, the historical assignment module 150 may also store information about the time a driver (i.e., field agent) departs from the dispatch center, the route recommended, the route taken, the estimated travel time, the actual travel time, the amount of time spent at the customer site handling the customer's task, etc.

In some embodiments, the historical assignment module 150 may generate a pairing model or similar computer processor-generate model based on a set of historical assignments for a period of time (e.g., the past week, the past month, the past year, etc.), which may be used by the task assignment strategy module 140 to make task assignment recommendations or instructions to the task assignment module 110. In other embodiments, the historical assignment module 150 may send historical assignment information to another module such as the task assignment strategy module 140 or the benchmarking module 160.

In some embodiments, a benchmarking module 160 may be communicatively coupled to and/or configured to operate in the task assignment system 100 via other modules such as the task assignment module 110 and/or the historical assignment module 150. The benchmarking module 160 may benchmark the relative performance of two or more pairing strategies (e.g., FIFO, PBR, BP, etc.) using historical assignment information, which may be received from, for example, the historical assignment module 150. In some embodiments, the benchmarking module 160 may perform other functions, such as establishing a benchmarking schedule for cycling among various pairing strategies, tracking cohorts (e.g., base and measurement groups of historical assignments), etc. The techniques for benchmarking and other functionality performed by the benchmarking module 160 for various task assignment strategies and various contexts are described in later sections throughout the present disclosure. Benchmarking is described in detail for the contact center context in, e.g., U.S. Pat. No. 9,712,676, which is hereby incorporated by reference herein.

In some embodiments, the benchmarking module 160 may output or otherwise report or use the relative performance measurements. The relative performance measurements may be used to assess the quality of the task assignment strategy to determine, for example, whether a different task assignment strategy (or a different pairing model) should be used, or to measure the overall performance (or performance gain) that was achieved within the task assignment system 100 while it was optimized or otherwise configured to use one task assignment strategy instead of another.

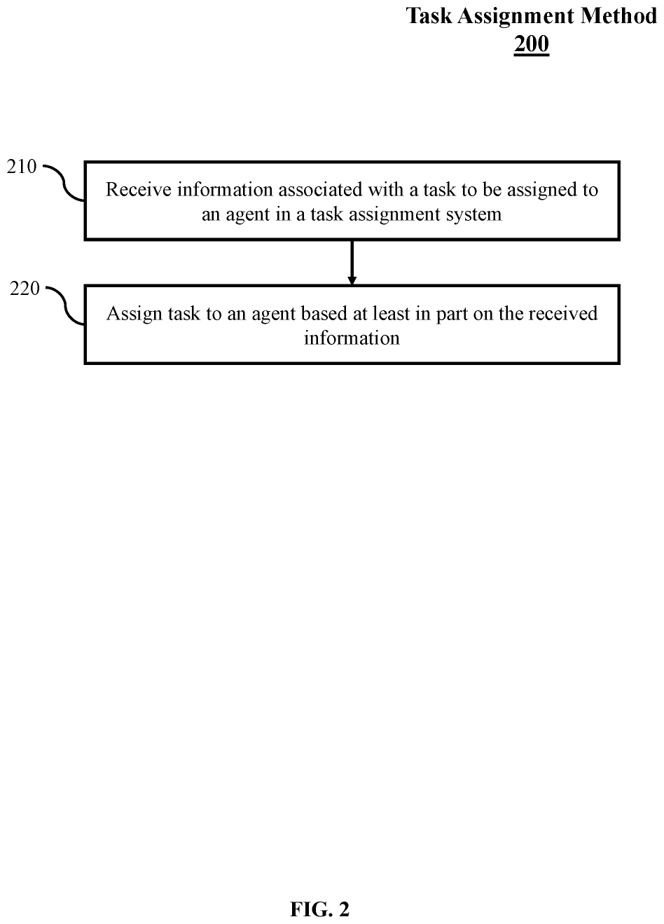

FIG. 2 shows a task assignment method 200 according to embodiments of the present disclosure. Task assignment method 200 may begin at block 210.

At block 210, information associated with a task to be assigned to an agent in a task assignment system (e.g., task assignment system 100) may be received. The receipt of the information may be triggered by an action taken by a user. The action may be taken by the user prior to requesting for the task to be assigned to an agent in the task assignment system. Task assignment method 200 may then proceed to block 220.

At block 220, the task may be assigned to an agent based at least in part on the received information associated with the task.

After assigning the at least one task to the agent, task assignment method 200 may end.

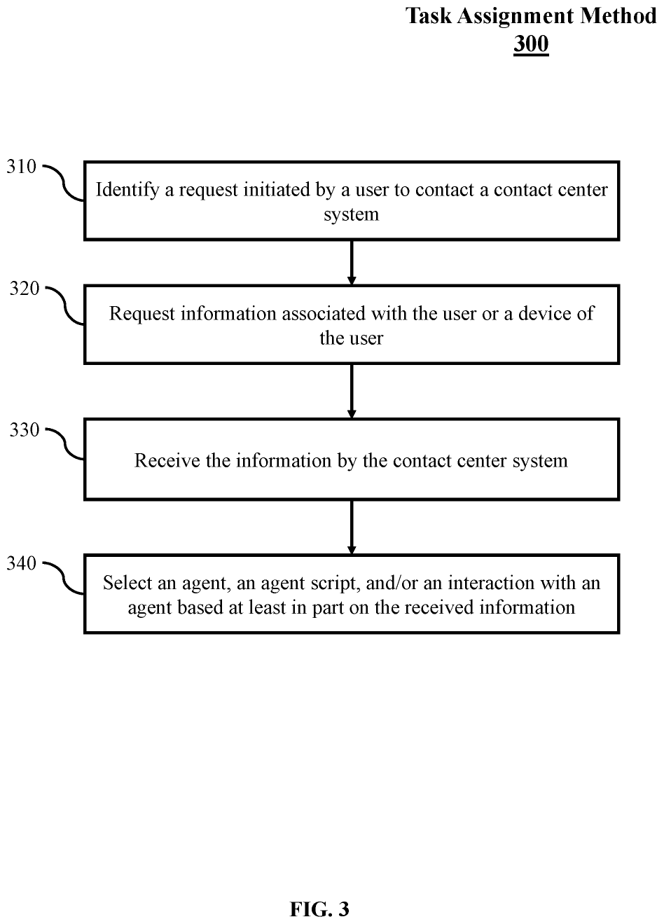

FIG. 3 shows a flow diagram of a task assignment method 300 according to embodiments of the present disclosure. Task assignment method 300 may begin at block 310.

At block 310, a request initiated by a user to contact a contact center system (e.g., task assignment system 100) may be identified. Task assignment method 300 may then proceed to block 320.

At block 320, information associated with the user or a device of the user may be requested. Task assignment method 300 may then proceed to block 330.

At block 330, the information associated with the user or a device of the user may be received. Task assignment method 300 may then proceed to block 340.

At block 340, an agent, an agent script, and/or an interaction with an agent may be selected based at least in part on the received information. It should be noted that the steps at blocks 330 and 340 may not be performed if the user does not contact the contact center system.

After assigning the at least one task to the agent, task assignment method 300 may end.

At this point it should be noted that task assignment in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for behavioral pairing in a task assignment system comprising:
receiving, by at least one computer processor communicatively coupled to and configured to operate in the task assignment system, information associated with a potential task to be assigned to an agent in the task assignment system, wherein receipt of the information is triggered by an action taken by a user.

2. The method of claim 1, wherein the task assignment system is a contact center system.

3. The method of claim 1, wherein the receipt of the information occurs prior to a request for the potential task to be assigned to an agent in the task assignment system.

4. The method of claim 1, wherein the potential task arrives at the task assignment system and is assigned to the agent based at least in part on the received information associated with the potential task.

5. The method of claim 1, wherein the potential task is terminated prior to arriving at the task assignment system and being assigned to the agent.

6. The method of claim 1, wherein the information associated with the potential task is at least one of a geographical location of where the potential task originates and a customer identification of the user initiating the potential task.

7. A method for behavioral pairing in a contact center system comprising:
identifying, by at least one computer processor communicatively coupled to and configured to operate in the contact center system, a request initiated by a user to contact the contact center system; and
requesting, by the at least one computer processor, in response to the identified request, information associated with the user from a device of the user.

8. The method of claim 7, further comprising receiving, by the at least one computer processor, the information from the device of the user.

9. The method of claim 8, wherein the user does not arrive at the contact center system.

10. The method of claim 8, wherein:
the user arrives at the contact center system, and
the method further comprises selecting, by the at least one computer processor, an agent based at least in part on the received information.

11. The method of claim 8, wherein
the user arrives at the contact center system, and
the method further comprises selecting, by the at least one computer processor, an agent script or an interaction with an agent based at least in part on the received information.

12. A system for behavioral pairing in a task assignment system comprising:
at least one computer processor communicatively coupled to and configured to operate in the task assignment system, wherein the at least one computer processor is further configured to:
receive information associated with a potential task to be assigned to an agent in the task assignment system, wherein receipt of the information is triggered by an action taken by a user.

13. The system of claim 12, wherein the task assignment system is a contact center system.

14. The system of claim 12, wherein the receipt of the information occurs prior to a request for the potential task to be assigned to an agent in the task assignment system.

15. The system of claim 12, wherein the potential task arrives at the task assignment system and is assigned to the agent based at least in part on the received information associated with the potential task.

16. The system of claim 12, wherein the potential task is terminated prior to arriving at the task assignment system and being assigned to the agent.

17. The system of claim 12, wherein the information associated with the potential task is at least one of a geographical location of where the potential task originates and a customer identification of the user initiating the potential task.

18. A system for behavioral pairing in a contact center system comprising:
at least one computer processor communicatively coupled to and configured to operate in the contact center system, wherein the at least one computer processor is further configured to:
identify a request initiated by a user to contact the contact center system; and
request, in response to the identified request, information associated with the user from a device of the user.

19. The system of claim 18, the at least one computer processor is further configured to receive the information from the device of the user.

20. The system of claim 19, wherein the user does not arrive at the contact center system.

21. The system of claim 19, wherein:
the user arrives at the contact center system, and
the at least one computer processor is further configured to select an agent based at least in part on the received information.

22. The method of claim 19, wherein
the user arrives at the contact center system, and
the at least one computer processor is further configured to select an agent script or an interaction with an agent based at least in part on the received information.

23. An article of manufacture for behavioral pairing in a task assignment system comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
receive information associated with a potential task to be assigned to an agent in the task assignment system, wherein receipt of the information is triggered by an action taken by a user.

24. An article of manufacture for behavioral pairing in a contact center system comprising:
a non-transitory processor readable medium; and
instructions stored on the medium;
wherein the instructions are configured to be readable from the medium by at least one computer processor communicatively coupled to and configured to operate in the contact center system and thereby cause the at least one computer processor to operate so as to:
identify a request initiated by a user to contact the contact center system; and
request, in response to the identified request, information associated with the user from a device of the user.
